(19) United States
(12) Patent Application Publication
(10) Pub. No.: US 2025/0269601 A1
(43) Pub. Date: Aug. 28, 2025

(54) METHOD FOR MANUFACTURING THREE-DIMENSIONAL SHAPED OBJECT AND INFORMATION PROCESSING DEVICE

(71) Applicant: SEIKO EPSON CORPORATION, Tokyo (JP)

(72) Inventor: Keigo ISHIKURA, SHIOJIRI-SHI (JP)

(21) Appl. No.: 19/061,016

(22) Filed: Feb. 24, 2025

(30) Foreign Application Priority Data
Feb. 27, 2024 (JP) 2024-027066

(51) Int. Cl. B29C 64/386; B33Y 50/00

(52) U.S. Cl. CPC B29C 64/386; B33Y 50/00

(57) ABSTRACT

A method for manufacturing a three-dimensional shaped object includes: a first process of specifying a missing region in the three-dimensional shaped object, based on first data that includes path data representing a path along which an ejection unit moves relatively to a stage while ejecting a shaping material and that includes amount-of-ejection data representing an amount of ejection of the shaping material in the path; a second process of accepting a designation of an allowable amount of overlap, which is an allowable amount of overlapping of partial shaped objects corresponding to paths adjacent to each other in a same layer; a third process of generating shaping data from the first data in such a way that a partial shaped object to fill the missing region is generated, when it is determined that the missing region can be filled by superimposing the partial shaped objects on each other within a range of the designated allowable amount of overlap; and a fourth process of controlling the relative movement of the ejection unit to the stage, based on the shaping data, and thus shaping the three-dimensional shaped object.

The present application is based on, and claims priority from JP Application Serial Number 2024-027066, filed Feb. 27, 2024, the disclosure of which is hereby incorporated by reference herein in its entirety.

### BACKGROUND

### 1. Technical Field

The present disclosure relates to a method for manufacturing a three-dimensional shaped object and an information processing device.

### 2. Related Art

Regarding a method for manufacturing a three-dimensional shaped object, for example, JP-T-2009-525207 describes that a nozzle for extruding a shaping material is moved along a build path for building each layer of a three-dimensional shaped object. The build path includes a perimeter path, a bulk raster path, and a remnant path. The perimeter path is a path for forming a boundary between the three-dimensional shaped object and the outside, and the bulk raster path is a path for filling a region surrounded by the perimeter path. In the technique described in JP-T-2009-525207, a void region which is not filled by the perimeter path and the bulk raster path is filled by the remnant path, and the porosity is thus reduced.

JP-T-2009-525207 is an example of the related art.

When the void region is filled by the remnant path, depending on the shape of the void region, an additional remnant path may not be generated well and a void part may remain, generating a missing part in the three-dimensional shaped object.

### SUMMARY

According to a first aspect of the present disclosure, a method for manufacturing a three-dimensional shaped object in which a shaping material is ejected from an ejection unit toward a stage to stack a layer, thus manufacturing a three-dimensional shaped object, is provided. This manufacturing method includes: a first process of specifying a missing region in the three-dimensional shaped object, based on first data that includes path data representing a path along which the ejection unit moves relatively to the stage while ejecting the shaping material and that includes amount-of-ejection data representing an amount of ejection of the shaping material in the path; a second process of accepting a designation of an allowable amount of overlap, which is an allowable amount of overlapping of partial shaped objects corresponding to paths adjacent to each other in a same layer; a third process of generating shaping data from the first data in such a way that a partial shaped object to fill the missing region is generated, when it is determined that the missing region can be filled by superimposing the partial shaped objects on each other within a range of the designated allowable amount of overlap; and a fourth process of controlling the relative movement of the ejection unit to the stage, based on the shaping data, and thus shaping the three-dimensional shaped object.

According to a second aspect of the present disclosure, an information processing device that generates shaping data for ejecting a shaping material from an ejection unit toward a stage to stack a layer and thus shaping a three-dimensional shaped object is provided. The information processing device includes: an acquisition unit configured to acquire first data that includes path data representing a path along which the ejection unit moves relatively to the stage while ejecting the shaping material and that includes amount-of-ejection data representing an amount of ejection of the shaping material in the path; a specifying unit configured to specify a missing region in the three-dimensional shaped object, based on the first data; an acceptance unit configured to accept a designation of an allowable amount of overlap, which is an allowable amount of overlapping of partial shaped objects corresponding to paths adjacent to each other in a same layer; and a data generation unit configured to generate shaping data from the first data in such a way that a partial shaped object to fill the missing region is generated, when it is determined that the missing region can be filled by superimposing the partial shaped objects on each other within a range of the designated allowable amount of overlap.

### BRIEF DESCRIPTION OF THE DRAWINGS

FIG. 1 is a diagram illustrating a schematic configuration of a three-dimensional shaping system.

FIG. 2 is a perspective view illustrating a schematic configuration of a screw.

FIG. 3 is a schematic plan view of a barrel.

FIG. 4 is a diagram schematically illustrating a state where a three-dimensional shaping device shapes a shaped object.

FIG. 5 is a diagram illustrating a schematic configuration of an information processing device.

FIG. 6 is a flowchart of shaping processing executed in the three-dimensional shaping system.

FIG. 7 is a diagram illustrating an example of a missing region in a first embodiment.

FIG. 8 is a diagram illustrating a state where a new partial shaped object to fill a missing region is generated.

FIG. 9 is a diagram illustrating shape data of a layer to be a generation target of shaping data in a second embodiment.

FIG. 10 is a diagram visualizing the shaping data when a missing region is generated in a second part.

FIG. 11 is a diagram visualizing the shaping data when an allowable amount of overlap is set for an outline region.

FIG. 12 is a diagram visualizing the shaping data when a missing region is generated in an infill region in the second part.

FIG. 13 is a diagram visualizing the shaping data when an allowable amount of overlap is set for the infill region in the second part.

FIG. 14 is a diagram visualizing the shaping data when a missing region is generated between the outline region and the infill region.

FIG. 15 is a diagram visualizing the shaping data when the allowable amount of overlap is set to be 10%.

FIG. 16 is a diagram visualizing the shaping data when the allowable amount of overlap is set to be 50%.

FIG. 17 is a diagram illustrating a state where the missing region is broadened.

FIG. 18 is a flowchart of shaping processing executed in a fifth embodiment.

### DESCRIPTION OF EMBODIMENTS

### A. First Embodiment

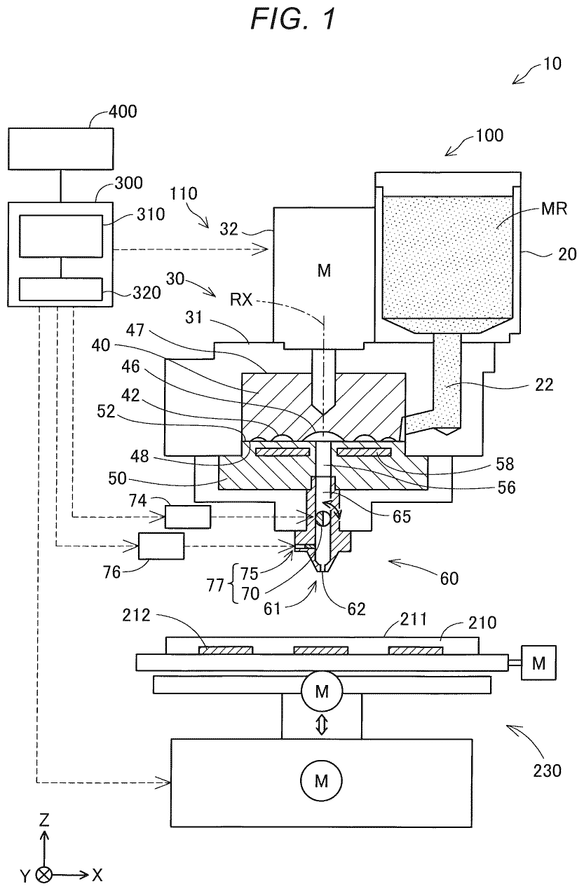

FIG. 1 is a diagram illustrating a schematic configuration of a three-dimensional shaping system 10 according to a first embodiment. In FIG. 1, arrows indicating X, Y, and Z directions orthogonal to one another are shown. The X direction and the Y direction are directions parallel to a horizontal plane, and the Z direction is a direction along a vertically upward direction. The arrows indicating the X, Y, and Z directions are illustrated as appropriate in other drawings as well in such a way that the illustrated directions correspond to those in FIG. 1. In the description below, to specify a direction, a direction indicated by an arrow in the drawings is defined as “+” and a direction opposite to that direction is defined as “−”, and the positive and negative signs are also used in the representation of directions. In the description below, a +Z direction is also referred to as “up”, and a −Z direction is also referred to as “down”.

The three-dimensional shaping system 10 includes a three-dimensional shaping device 100 and an information processing device 400. The three-dimensional shaping device 100 in the embodiment is a device that shapes a shaped object by a material extrusion method. The three-dimensional shaping device 100 includes a control unit 300 for controlling each part of the three-dimensional shaping device 100. The control unit 300 and the information processing device 400 are communicably coupled.

The three-dimensional shaping device 100 includes a shaping unit 110 that generates and ejects a shaping material, a stage 210 for shaping that serves as a base for a shaped object, and a movement mechanism 230 that controls an ejection position of the shaping material.

The shaping unit 110 ejects a shaping material formed by plasticizing a solid-state material onto the stage 210 under the control of the control unit 300. The shaping unit 110 includes a material supply unit 20, which is a supply source of a raw material before being converted into the shaping material, a plasticizing unit 30 which converts the raw material into the shaping material, and an ejection unit 60 which ejects the shaping material.

The material supply unit 20 supplies a raw material MR to the plasticizing unit 30. The material supply unit 20 is configured with, for example, a hopper that accommodates the raw material MR. The material supply unit 20 is coupled to the plasticizing unit 30 via a communication path 22. The raw material MR is put into the material supply unit 20 in the form of powder or pellets. As the raw material MR, for example, thermoplastic resins such as an acrylonitrile-butadiene-styrene resin (ABS), a polypropylene resin (PP), a polyethylene resin (PE), and a polyacetal resin (POM) are used.

The plasticizing unit 30 plasticizes the raw material MR supplied from the material supply unit 20, thus generates a paste-like shaping material exhibiting fluidity, and guides the shaping material to the ejection unit 60. In the embodiment, the term “plasticize” refers to a concept including melting and means changing a solid state to a fluid state. Specifically, in the case of a material in which glass transition occurs, plasticizing means setting the temperature of the material to be equal to or higher than the glass transition point. In the case of a material in which glass transition does not occur, plasticizing means setting the temperature of the material to be equal to or higher than the melting point.

The plasticizing unit 30 includes a screw case 31, a drive motor 32, a screw 40, and a barrel 50. The screw 40 is also called a rotor, a scroll, or a flat screw. The barrel 50 is also referred to as a screw-facing part.

The screw 40 is housed in the screw case 31. An upper surface 47 of the screw 40 is coupled to the drive motor 32, and the screw 40 rotates in the screw case 31 due to a rotational driving force generated by the drive motor 32. The drive motor 32 is driven under the control of the control unit 300. The screw 40 may be driven by the drive motor 32 via a decelerator.

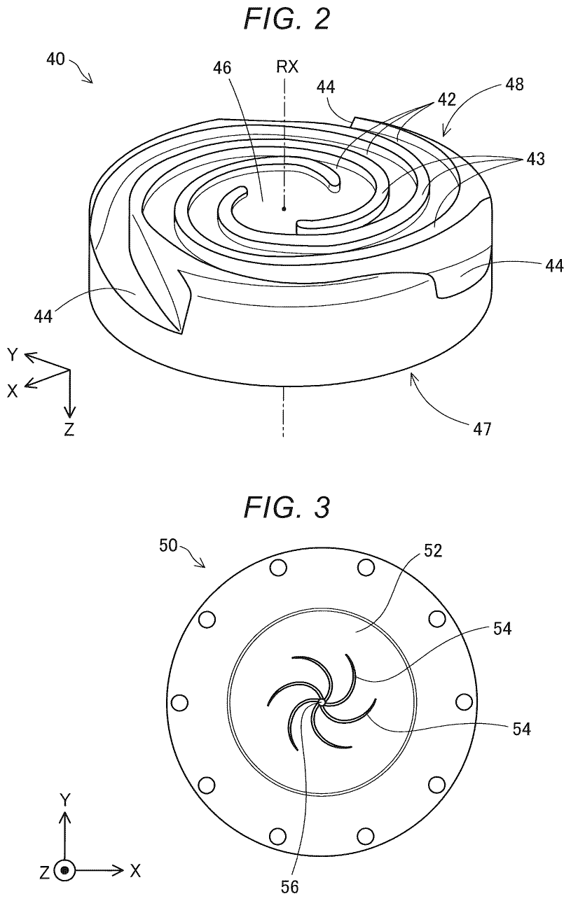

FIG. 2 is a perspective view illustrating a schematic configuration on the side of a lower surface 48 of the screw 40. To facilitate the understanding of the technique, the screw 40 illustrated in FIG. 2 is illustrated in a state where the positional relationship between the upper surface 47 and the lower surface 48 illustrated in FIG. 1 is reversed in the vertical direction. The screw 40 has a substantially cylindrical shape whose length in an axial direction that is a direction along a central axis thereof is shorter than the length in a direction perpendicular to the axial direction. The screw 40 is disposed in such a way that a rotation axis RX that is a rotation center thereof is parallel to the Z direction.

Grooves 42 in a vortex shape are formed in the lower surface 48, which is a surface intersecting the rotation axis RX, of the screw 40. The communication path 22 of the material supply unit 20 communicates with the grooves 42 from the side surface of the screw 40. In the embodiment, three grooves 42 are formed, separated from each other by protruding parts 43. The number of the grooves 42 is not limited to three and may be one or may be two or more. The grooves 42 are not limited to the vortex shape and may have a spiral shape or an involute curve shape, or may have a shape extending arcuately from the central part toward the outer circumference.

As illustrated in FIG. 1, the lower surface 48 of the screw 40 faces an upper surface 52 of the barrel 50, and a space is formed between the grooves 42 in the lower surface 48 of the screw 40 and the upper surface 52 of the barrel 50. The raw material MR is supplied into the space between the screw 40 and the barrel 50 from the material supply unit 20 through material inlets 44 illustrated in FIG. 2.

A barrel heater 58 for heating the raw material MR supplied into the grooves 42 of the rotating screw 40 is embedded in the barrel 50. A communication hole 56 is provided at the center of the barrel 50.

FIG. 3 is a schematic plan view illustrating an upper surface 52 side of the barrel 50. A plurality of guide grooves 54 coupled to the communication hole 56 and extending in a vortex shape from the communication hole 56 toward the outer circumference is formed in the upper surface 52 of the barrel 50. One end of the guide grooves 54 may not be coupled to the communication hole 56. The guide grooves 54 may be omitted.

The raw material MR supplied into the grooves 42 of the screw 40 flows along the grooves 42 due to the rotation of the screw 40 while being plasticized in the grooves 42, and is guided to a central part 46 of the screw 40 as the shaping material. The paste-like shaping material exhibiting fluidity, which flows into the central part 46, is supplied to the ejection unit 60 via the communication hole 56 provided at the center of the barrel 50. In the shaping material, not all the kinds of substances forming the shaping material may be plasticized. The shaping material may be converted into a fluid state as a whole by plasticizing at least a part of the kinds of substances forming the shaping material.

The ejection unit 60 illustrated in FIG. 1 includes a nozzle 61 that ejects the shaping material, a flow path 65 for the shaping material that is formed between the screw 40 and a nozzle opening 62, and an ejection control unit 77 that controls the ejection of the shaping material.

The nozzle 61 is coupled to the communication hole 56 of the barrel 50 through the flow path 65. The nozzle 61 ejects the shaping material generated by the plasticizing unit 30, from the nozzle opening 62 at the distal end toward the stage 210.

The ejection control unit 77 includes an ejection adjustment unit 70 that opens and closes the flow path 65 and a suction unit 75 that suctions and temporarily stores the shaping material.

The ejection adjustment unit 70 is provided in the flow path 65 and changes the opening degree of the flow path 65 by rotating in the flow path 65. In the embodiment, the ejection adjustment unit 70 is configured with a valve. The ejection adjustment unit 70 is driven by a first drive unit 74 under the control of the control unit 300. The first drive unit 74 is configured with, for example, a stepping motor. The control unit 300 controls the rotation angle of the ejection adjustment unit 70, using the first drive unit 74, and thus can adjust the flow rate of the shaping material flowing from the plasticizing unit 30 to the nozzle 61, that is, the amount of ejection of the shaping material ejected from the nozzle 61. The ejection adjustment unit 70 can adjust the amount of ejection of the shaping material and can control the ON and OFF of the outflow of the shaping material.

The suction unit 75 is coupled at a site between the ejection adjustment unit 70 and the nozzle opening 62 in the flow path 65. The suction unit 75 temporarily suctions the shaping material in the flow path 65 when the ejection of the shaping material from the nozzle 61 is stopped, and thereby suppresses a trailing phenomenon in which the shaping material hangs down like a string from the nozzle opening 62. In the embodiment, the suction unit 75 is configured with a plunger. The suction unit 75 is driven by a second drive unit 76 under the control of the control unit 300. The second drive unit 76 is configured with, for example, a stepping motor or a rack-and-pinion mechanism that converts a rotational force generated by the stepping motor into a translational motion of the plunger, or the like.

The stage 210 is disposed at a position facing the nozzle opening 62 of the nozzle 61. In the first embodiment, a shaping surface 211 of the stage 210 facing the nozzle opening 62 of the nozzle 61 is parallel to the X and Y directions, that is, a horizontal direction. The stage 210 includes a stage heater 212 for suppressing sudden cooling of the shaping material ejected onto the stage 210. The stage heater 212 is controlled by the control unit 300.

The movement mechanism 230 changes the relative position between the stage 210 and the nozzle 61 under the control of the control unit 300. In the embodiment, the position of the nozzle 61 is fixed, and the movement mechanism 230 moves the stage 210. The movement mechanism 230 is configured with a three-axis positioner that moves the stage 210 in three axial directions, that is, the X, Y, and Z directions, by the driving forces of three motors. In the present specification, the movement of the nozzle 61 means moving the nozzle 61 or the ejection unit 60 relatively to the stage 210, unless stated otherwise.

In another embodiment, a configuration in which the movement mechanism 230 moves the nozzle 61 in relation to the stage 210 in the state where the position of the stage 210 is fixed may be employed instead of the configuration in which the movement mechanism 230 moves the stage 210. Also, a configuration in which the movement mechanism 230 moves the stage 210 in the Z direction and moves the nozzle 61 in the X and Y directions, or a configuration in which the movement mechanism 230 moves the stage 210 in the X and Y directions and moves the nozzle 61 in the Z direction may be employed. With these configurations, too, the relative positional relationship between the nozzle 61 and the stage 210 can be changed.

While only one shaping unit 110 is illustrated in FIG. 1, the three-dimensional shaping device 100 may include a plurality of shaping units 110. When the plurality of shaping units 110 are provided, different types of shaping materials can be ejected from the respective shaping units 110. Therefore, for example, a main body of the shaped object and a support structure supporting the shaped object can be formed with different types of shaping materials.

The control unit 300 is a control device that controls operations of the entire three-dimensional shaping device 100. The control unit 300 is configured with a computer including one or a plurality of processors 310, a storage device 320 made up of a main storage device and an auxiliary storage device, and an input/output interface for inputting and outputting a signal from and to outside. The processor 310 executes a program stored in the storage device 320 to control the shaping unit 110 and the movement mechanism 230 according to shaping data acquired from the information processing device 400, and thus shapes a shaped object on the stage 210. The control unit 300 may be implemented by combining circuits together, instead of being configured with a computer.

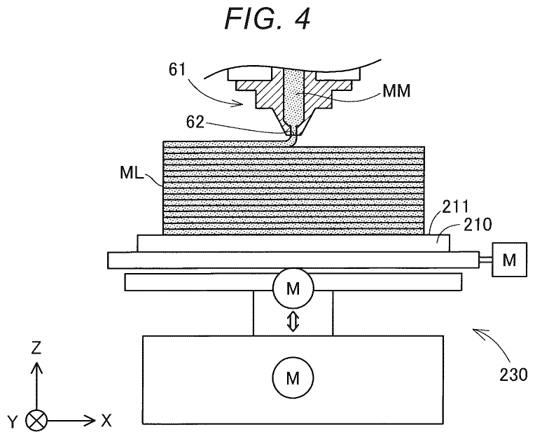

FIG. 4 is a diagram schematically illustrating the state where the three-dimensional shaping device 100 shapes a shaped object. As described above, in the three-dimensional shaping device 100, the solid-state raw material MR is plasticized to generate a shaping material MM. The control unit 300 causes the nozzle 61 to eject the shaping material MM while changing the position of the nozzle 61 in relation to the stage 210 in a direction along the shaping surface 211 of the stage 210, maintaining the distance between the shaping surface 211 of the stage 210 and the nozzle 61. The shaping material MM ejected from the nozzle 61 is continuously deposited in the direction of movement of the nozzle 61.

The control unit 300 repeats the movement of the nozzle 61 and thus forms layers ML. After forming one layer ML, the control unit 300 moves the position of the nozzle 61 in relation to the stage 210 in the Z direction, which is the stacking direction of the layers ML. Then, the control unit 300 stacks another layer ML on the already formed layers ML and thus shapes the shaped object.

For example, when the nozzle 61 is moved in the Z direction on completion of one layer ML or when there is a plurality of independent shaping regions in each layer, the control unit 300 may temporarily suspend the ejection of the shaping material from the nozzle 61. In this case, the flow path 65 is closed by the ejection adjustment unit 70, the ejection of the shaping material MM from the nozzle opening 62 is stopped, and the shaping material in the nozzle 61 is temporarily suctioned by the suction unit 75. After changing the position of the nozzle 61, the control unit 300 discharges the shaping material from inside the suction unit 75 and opens the flow path 65 by the ejection adjustment unit 70, and thus resumes the deposition of the shaping material MM from the changed position of the nozzle 61.

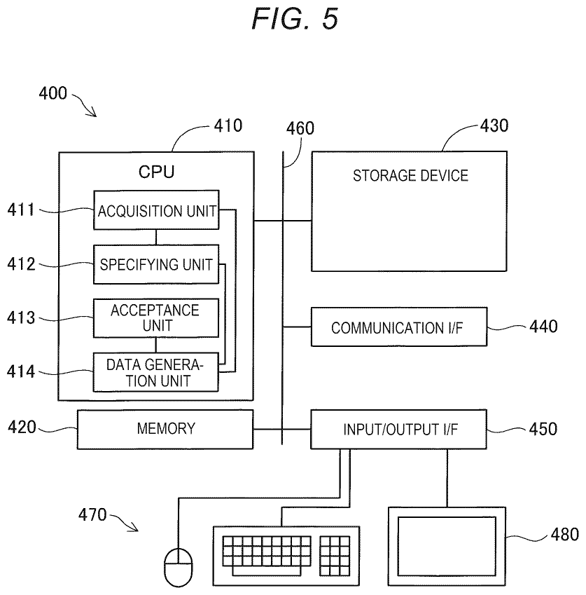

FIG. 5 is a diagram illustrating a schematic configuration of the information processing device 400. The information processing device 400 is configured as a computer in which a CPU 410, a memory 420, a storage device 430, a communication interface 440, and an input/output interface 450 are coupled to each other via a bus 460. An input device 470 such as a keyboard and a mouse and a display unit 480 such as a liquid crystal display are coupled to the input/output interface 450. The information processing device 400 is coupled to the control unit 300 of the three-dimensional shaping device 100 via the communication interface 440.

The CPU 410 executes a program stored in the storage device 430 and thus functions as an acquisition unit 411, a specifying unit 412, an acceptance unit 413, and a data generation unit 414.

The acquisition unit 411 acquires first data. The first data includes path data representing a path along which the ejection unit 60 moves relatively to the stage 210 while ejecting the shaping material, and also includes amount-of-ejection data representing an amount of ejection of the shaping material in each path The path is also called a path.

The specifying unit 412 specifies a missing region in the three-dimensional shaped object, based on the first data. The missing region will be described later.

The acceptance unit 413 accepts a designation of an allowable amount of overlap, which is an allowable amount of overlapping of partial shaped objects corresponding to paths adjacent to each other in the same layer. The paths adjacent to each other refer to paths arranged adjacent to each other in parallel or substantially in parallel. The partial shaped object corresponding to the path is a shaped object formed by depositing a shaping material on the stage 210 as the ejection unit 60 ejects the shaping material along the path, and refers to a shaped object forming a part of the three-dimensional shaped object. While the path does not have a width, the partial shaped object has a width. The width of the partial shaped object is referred to as a line width.

The data generation unit 414 generates shaping data from the first data in such a way that a partial shaped object that fills the missing region is generated, when it is determined that the missing region can be filled by superimposing the partial shaped objects on each other within the range of the designated allowable amount of overlap. The partial shaped object that fills the missing region may be a partial shaped object added independently of the existing partial shaped object, or may be a partial shaped object added by extending the existing partial shaped object. The shaping data may be referred to as second data.

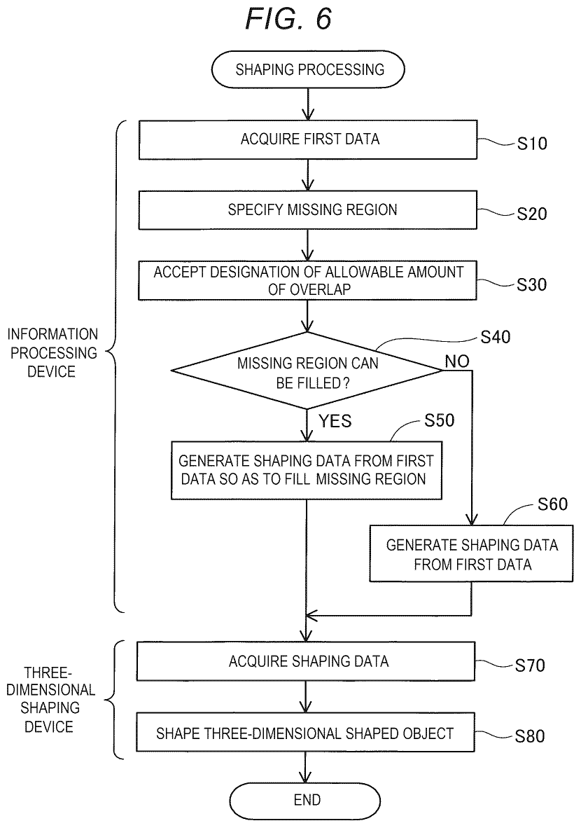

FIG. 6 is a flowchart of shaping processing executed in the three-dimensional shaping system 10. The shaping processing is processing for implementing a method for manufacturing a three-dimensional shaped object. The processing of steps S10 to S60 shown in FIG. 6 is executed by the information processing device 400, and the processing of steps S70 to S80 is executed by the three-dimensional shaping device 100.

In step S10, the acquisition unit 411 of the information processing device 400 acquires the first data from the storage device 430. As described above, the first data includes the path data representing the path along which the ejection unit 60 moves relatively to the stage 210 while ejecting the shaping material, and also includes the amount-of-ejection data representing the amount of ejection of the shaping material in each path. The first data includes the path data and the amount-of-ejection data for each layer ML of the three-dimensional shaped object. The path data includes a plurality of linear paths. The amount-of-ejection data is individually associated with each path. As the shaping material in an amount defined by the amount-of-ejection data is ejected toward the stage 210 along each path, a linear partial shaped object which is a part of the three-dimensional shaped object is formed at the top of the stage 210. The amount-of-ejection data corresponding to each path is set in such a way that the line width of the partial shaped object formed at the top of the stage 210 becomes a predetermined width.

Prior to the execution of step S10, the CPU 410 of the information processing device 400 may acquire shape data representing a three-dimensional shape of the three-dimensional shaped object from another computer, a recording medium, or the storage device 430, generate first data from the shape data, and store the first data in the storage device 430. The shape data is data representing the shape of the three-dimensional shaped object created using three-dimensional CAD software, three-dimensional CG software, or the like. As the shape data, for example, data in the STL format or the AMF format or the like is used.

In step S20, the specifying unit 412 specifies a missing region in the three-dimensional shaped object, based on the first data acquired in step S10. Step S20 is equivalent to a first process according to the present disclosure.

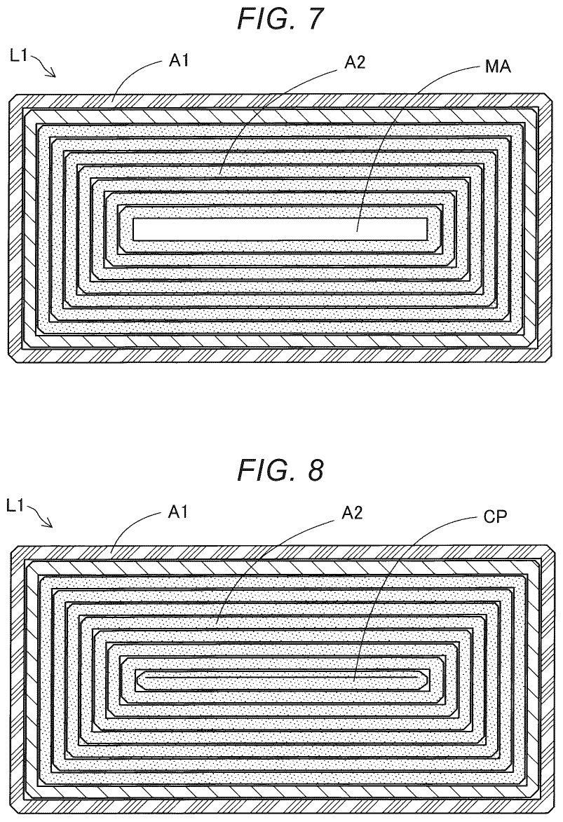

FIG. 7 is a diagram illustrating an example of the missing region in the first embodiment. FIG. 7 shows an outline region A1 and an infill region A2 forming a certain layer L1 of the three-dimensional shaped object. The outline region A1 is a region forming the outline of the three-dimensional shaped object, and the infill region A2 is a region located on the inner side of the outline region A1. In FIG. 7, in the outline region A1, based on two circulation paths, a partial shaped object corresponding to the two circulation paths is formed, and in the infill region A2, based on seven circulation paths, a partial shaped object corresponding to the seven circulation paths is formed. The circulation path is a path that makes a full round as a continuous path. The path that goes around is a path where a start point and an end point are successive. In the drawings from FIG. 7 onward, the partial shaped object is hatched.

In the layer L1, a rectangular void is formed in the center of the infill region A2. To fill this void with a partial shaped object shaped by a circulation path, the void needs to have a width twice the line width of the partial shaped object. Therefore, when the width of the void is less than twice the line width of the partial shaped object, the void is not filled with the partial shaped object and becomes a missing region MA. In the first embodiment, the specifying unit 412 analyzes the first data, detects a void that is not filled with the partial shaped object shaped by the circulation path, and specifies the void as the missing region MA.

In step S30 in FIG. 6, the acceptance unit 413 accepts a designation of an allowable amount of overlap, which is the allowable amount of overlapping of partial shaped objects corresponding to paths adjacent to each other in the same layer. Step S30 is equivalent to a second process according to the present disclosure. In the first embodiment, in step S30, the allowable amount of overlap is designated for the partial shaped objects corresponding to the paths adjacent to each other, of the circulation paths. For example, the acceptance unit 413 accepts the designation of the allowable amount of overlap from the user through the input device 470. The user designates the allowable amount of overlap, for example, in the form of a numerical value or a ratio. When the line width of the partial shaped object corresponding to the path is 1 mm, the allowable amount of overlap can be designated within the range of 0 mm to 1 mm, or within the range of 0% to 100%. When the allowable amount of overlap is 0%, the adjacent partial shaped objects do not overlap each other. When the allowable amount of overlap is 100%, the adjacent partial shaped objects completely overlap each other. That is, as the allowable amount of overlap becomes larger, the overlap between the partial shaped objects becomes larger and therefore the missing region MA having a narrow width can be filled. However, as the allowable amount of overlap increases, the ratio of the partial shaped objects overlapping in the vertical direction increases and the shaping accuracy of the three-dimensional shaped object may drop. Therefore, preferably, an upper limit of the allowable amount of overlap may be provided. The upper limit is, for example, 50%.

In step S40, the data generation unit 414 determines whether the missing region MA can be filled by superimposing the partial shaped objects within the range of the allowable amount of overlap accepted in step S30. In the first embodiment, the data generation unit 414 generates a new circulation path that satisfies the designated allowable amount of overlap, and fills the missing region MA with the new partial shaped object shaped by the circulation path. Therefore, for example, when the line width of the partial shaped object is 1 mm, the width of the missing region MA is 1.5 mm, and a value of 0.5 mm or more or 50% or more is designated as the allowable amount of overlap, it is determined that the missing region MA can be filled with a new partial shaped object that makes a full round.

When the data generation unit 414 determines in step S40 that the missing region MA can be filled, the data generation unit 414 in step S50 generates shaping data from the first data in such a way that a new partial shaped object to fill the missing region MA is generated. Step S50 is equivalent to a third process according to the present disclosure.

FIG. 8 is a diagram illustrating the state where a new partial shaped object to fill the missing region MA is generated. FIG. 8 illustrates an example in which the missing region MA illustrated in FIG. 7 is filled with a partial shaped object shaped by a new circulation path CP. The data generation unit 414 newly generates a circulation path for shaping a partial shaped object that makes a full round, including the overlapping part within the range of the allowable amount of overlap, and adds path data representing the circulation path and the amount-of-ejection data to the first data, and thus generates shaping data.

When the data generation unit 414 determines in step S40 that the missing region MA cannot be filled, the data generation unit 414 in step S60 generates shaping data from the first data without adding new path data and amount-of-ejection data to the first data. Specifically, the first data is not changed, and the first data is used as the shaping data.

When the data generation unit 414 determines in step S40 that the missing region MA cannot be filled, the CPU 410 of the information processing device 400 may cause the display unit 480 to display a warning indicating that the missing region MA cannot be filled. Also, when the data generation unit 414 determines in step S40 that the missing region MA cannot be filled, the CPU 410 may return the processing to step S30 and accept a designation of a new allowable amount of overlap from the user.

In step S70 in FIG. 6, the control unit 300 of the three-dimensional shaping device 100 acquires the shaping data generated in step S50 or step S60 from the information processing device 400.

In step S80, the control unit 300 controls the ejection unit 60 and the movement mechanism 230 according to the shaping data acquired from the information processing device 400, and shapes the three-dimensional shaped object on the shaping surface 211 of the stage 210. Step S80 is equivalent to a fourth process according to the present disclosure.

In the three-dimensional shaping system 10 according to the first embodiment described above, since the designation of the allowable amount of overlap between partial shaped objects is accepted from the user, a new partial shaped object including the overlapping part within the range of the designated allowable amount of overlap is generated and the missing region MA can be filled with the new partial shaped object. Therefore, the void part can be suppressed from being left in the three-dimensional shaped object. Thus, the shaping accuracy of the three-dimensional shaped object can be improved.

Also, in the first embodiment, the allowable amount of overlap is designated for partial shaped objects corresponding to paths adjacent to each other, of the circulation paths, each making a full round as a continuous path. Therefore, the missing region MA generated in the circulation paths is filled more easily.

### B. Second Embodiment

The configuration of a three-dimensional shaping system 10 according to a second embodiment is the same as that of the three-dimensional shaping system 10 according to the first embodiment. In the second embodiment, the processing contents of steps S20 to S60 of the shaping processing illustrated in FIG. 6 are different from those of the first embodiment. Since the processing contents of the other steps are the same as those of the first embodiment, detailed description thereof will be omitted.

In the second embodiment, in step S20 of the shaping processing illustrated in FIG. 6, the specifying unit 412 individually specifies the missing region MA for each of the outline region A1 and the infill region A2 forming the layer, based on the first data acquired in step S10.

In step S30, the acceptance unit 413 accepts a designation of an allowance amount of overlap for partial shaped objects corresponding to paths adjacent to each other in the outline region A1, and also accepts a designation of another allowable amount of overlap for partial shaped objects corresponding to paths adjacent to each other in the infill region A2. That is, the designation of the allowable amount of overlap is accepted separately for the outline region A1 and for the infill region A2.

In step S40, the data generation unit 414 determines whether the missing region MA can be filled by arranging the partial shaped objects in such a way that the partial shaped objects overlap each other within the range of the allowable amount of overlap designated separately in the missing regions MA specified in the outline region A1 and the infill region A2, respectively. When the data generation unit 414 determines that the missing region MA can be filled, the data generation unit 414 in step S50 generates shaping data from the first data in such a way as to fill the missing region MA, whereas when the data generation unit 414 determines that missing region MA cannot be filled, the data generation unit 414 in step S60 generates shaping data from the first data without filling the missing region MA. When the determination result is different between the outline region A1 and the infill region A2, the data generation unit 414 generates shaping data from the first data in such a way as to fill the missing region MA in the region for which it is determined that the missing region MA can be filled.

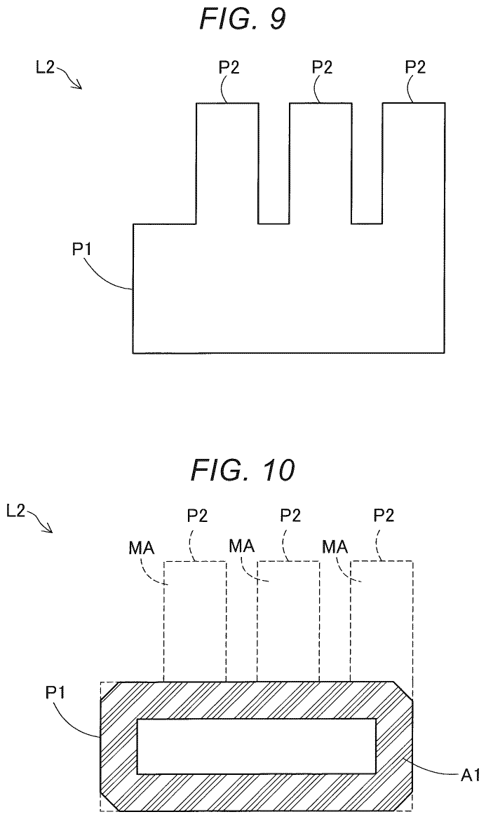

FIG. 9 is a diagram illustrating the shape data of a layer L2 to be a generation target of the shaping data in the second embodiment. The layer L2 has a rectangular first part P1 and three second parts P2 protruding from the first part P1.

FIG. 10 is a diagram visualizing the shaping data when the missing region MA is generated at the second part P2. Since the width of the second part P2 is narrow, when the overlap of the partial shaped objects is not allowed in the outline region A1, the partial shaped object may not be formed in the outline region A1 in the second part P2 and the partial shaped object may be formed only in the outline region A1 in the first portion P1, as illustrated in FIG. 10. In this case, the outline region A1 in the second part P2 is the missing region MA.

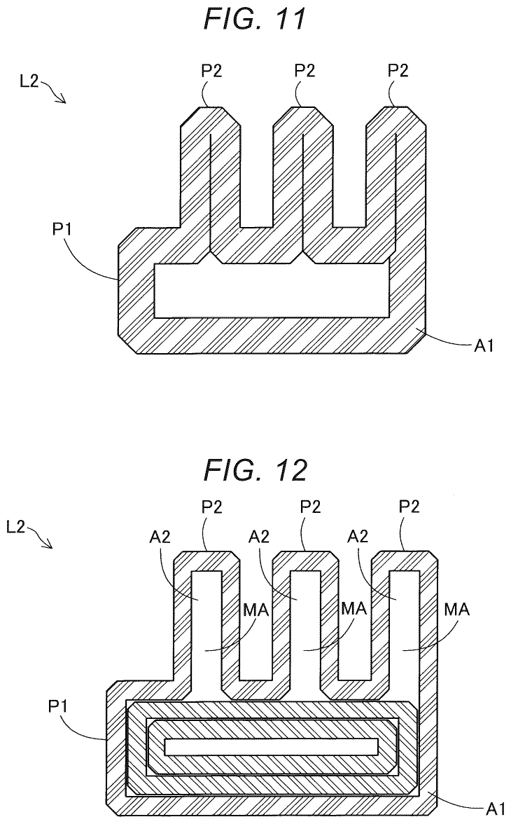

FIG. 11 is a diagram visualizing the shaping data when the allowable amount of overlap is set for the outline region A1. In the second embodiment, in step S30 of the shaping processing, an allowable amount of overlap is set separately for the outline region A1 and for the infill region A2. Therefore, as the allowable amount of overlap is set for the outline region A1, the data generation unit 414 can generate path data and amount-of-ejection data in such a way that a part of the partial shaped objects adjacent to each other is arranged, overlapping each other, at the second part P2 having a narrow width, as illustrated in FIG. 11. Thus, the generation of the missing region MA in the outline region A1 can be suppressed.

FIG. 12 is a diagram visualizing the shaping data when the missing region MA is generated in the infill region A2 in the second part P2. In the example illustrated in FIG. 12, the line width of the partial shaped object forming the outline region A1 is narrower than the line width of the partial shaped object illustrated in FIGS. 10 and 11. Since the width of the second part P2 is narrow, when the overlap of the partial shaped objects is not allowed in the infill region A2 in the second part P2, the partial shaped object may not be formed in the infill region A2 in the second part P2 and the missing region MA may be generated in the infill region A2, as illustrated in FIG. 12.

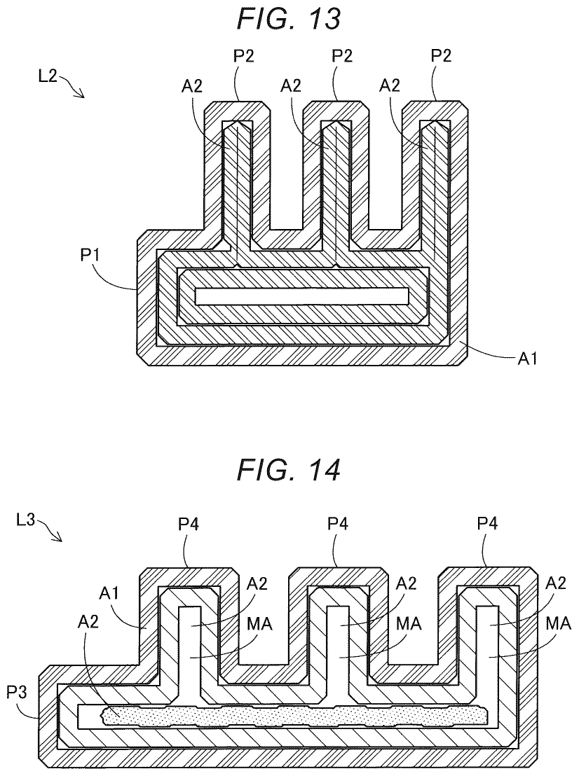

FIG. 13 is a diagram visualizing the shaping data when the allowable amount of overlap is set for the infill region A2 in the second part P2. In the second embodiment, in step S30 of the shaping processing, an allowable amount of overlap is set separately for the outline region A1 and for the infill region A2. Therefore, as the allowable amount of overlap is set for the infill region A2, the data generation unit 414 can generate path data and amount-of-ejection data in such a way that the partial shaped objects adjacent to each other are arranged, partly overlapping each other, in the infill region A2 in the second part P2 having a narrow width, as illustrated in FIG. 13. Thus, the generation of the missing region MA in the infill region A2 can be suppressed.

In the second embodiment described above, the allowable amount of overlap can be designated separately for the partial shaped object corresponding to the paths adjacent to each other in the outline region A1 and for the partial shaped object corresponding to the paths adjacent to each other in the infill region A2. Therefore, an appropriate allowable amount of overlap can be designated according to the region where the missing region MA is generated.

In the second embodiment, the acceptance unit 413 accepts the designation of the allowable amount of overlap separately for the outline region A1 and for the infill region A2. Meanwhile, the acceptance unit 413 may accept the designation of the allowable amount of overlap only for one of the outline region A1 and the infill region A2.

### C. Third Embodiment

The configuration of a three-dimensional shaping system 10 according to a third embodiment is the same as that of the three-dimensional shaping system 10 according to the first embodiment. In the third embodiment, the processing of steps S20 to S40 of the shaping processing illustrated in FIG. 6 is different from that of the first embodiment. Since the processing contents of the other steps are the same as those of the first embodiment, detailed description thereof will be omitted.

In the third embodiment, in step S20 of the shaping processing illustrated in FIG. 6, the specifying unit 412 specifies the missing region MA existing between the outline region A1 and the infill region A2 forming the layer, based on the first data acquired in step S10.

In step S30, the acceptance unit 413 accepts a designation of an allowable amount of overlap for the partial shaped object corresponding to the path in the outline region A1 and the partial shaped object corresponding to the path in the infill region A2 which are adjacent to each other. That is, the acceptance unit 413 accepts the designation of the allowable amount of overlap between the partial shaped objects adjacent to each other over the outline region A1 and the infill region A2.

In step S40, the data generation unit 414 determines whether the missing region MA specified in step S20 can be filled by superimposing the partial shaped objects adjacent to each other over the outline region A1 and the infill region A2 within the range of the allowable amount of overlap designated in step S30. When the data generation unit 414 determines that the missing region MA can be filled, the data generation unit 414 in step S50 generates shaping data from the first data in such a way as to fill the missing region MA. Specifically, path data and amount-of-ejection data for forming the partial shaped object in the infill region A2, in the outline region A1, while allowing the partial shaped object in the outline region A1 and the partial shaped object in the infill region A2 to overlap within the range of the allowable amount of overlap, are generated and recorded in the shaping data. When the data generation unit 414 determines that the missing region MA cannot be filled, the data generation unit 414 in step S60 generates shaping data from the first data without filling the missing region MA.

FIG. 14 is a diagram visualizing the shaping data when the missing region MA is generated between the outline region A1 and the infill region A2 forming a layer L3. The layer L3 illustrated in FIG. 14 includes a rectangular third part P3 and three fourth parts P4 protruding from the third part P3. In the example illustrated in FIG. 14, the outline region A1 is formed by partial shaped objects corresponding to two circulation paths, in the third part P3 and the fourth part P4. Although the partial shaped object is disposed at a part of the infill region A2 in the third part P3, the partial shaped object is not formed in the infill region A2 in the fourth part P4, and the missing region MA is generated there.

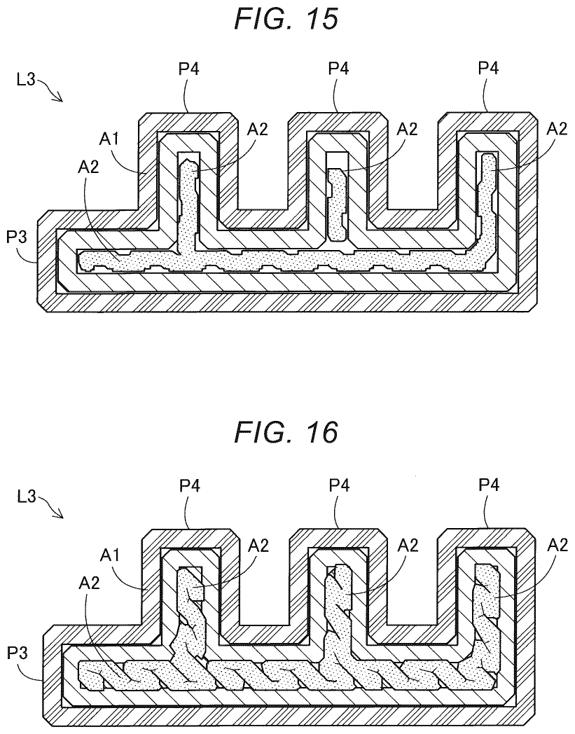

FIG. 15 is a diagram visualizing the shaping data when the allowable amount of overlap is set to be 10%. When the allowable amount of overlap between the partial shaped object in the infill region A2 and the partial shaped object in the outline region A1 adjacent to each other is set to be 10%, a new partial shaped object or a partial shaped object extended from the existing partial shaped object is arranged in the missing region MA illustrated in FIG. 14, and substantially the entirety of the infill region A2 in the third part P3 and the fourth part P4 is thus filled with the partial shaped object.

FIG. 16 is a diagram visualizing the shaping data when the allowable amount of overlap is set to be 50%. When the allowable amount of overlap between the partial shaped object in the infill region A2 and the partial shaped object in the outline region A1 adjacent to each other is set to be 50%, the partial shaped object is arranged over the entire infill region A2 in the third part P3 and the fourth part P4, compared with when the allowable amount of overlap is set to be 10%. However, when the allowable amount of overlap is increased, the shaping accuracy may drop due to the overlap of the partial shaped objects in the stacking direction, and therefore the allowable amount of overlap may be preferably set within a range of 1% to 50%.

In the third embodiment described above, the allowable amount of overlap is designated for the partial shaped object in the outline region A1 and the partial shaped object in the infill region A2 which are adjacent to each other. Therefore, the missing region MA generated between the outline region A1 and the infill region A2 is filled more easily.

### D. Fourth Embodiment

The configuration of a three-dimensional shaping system 10 according to a fourth embodiment is the same as that of the three-dimensional shaping system 10 according to the first embodiment. In the fourth embodiment, the processing of steps S30 to S50 of the shaping processing illustrated in FIG. 6 is different from that of the first embodiment. Since the processing contents of the other steps are the same as those of the first embodiment, detailed description thereof will be omitted.

In the fourth embodiment, in step S20 of the shaping processing illustrated in FIG. 6, the specifying unit 412 specifies the missing region MA, based on the first data acquired in step S10. In the fourth embodiment, as in the first embodiment, the first data is analyzed, a void that is not filled with the partial shaped object formed by the circulation path is detected, and the void is specified as the missing region MA.

In step S30, the acceptance unit 413 accepts a designation of an allowable amount of overlap between partial shaped objects corresponding to paths adjacent to each other around the missing region MA.

In step S40, the data generation unit 414 superimposes the partial shaped objects corresponding to the paths adjacent to each other around the missing region MA specified in step S20 within the range of the allowable amount of overlap specified in step S30, thus expands the missing region MA, and determines whether the expanded missing region MA can be filled with a new partial shaped object. When the data generation unit 414 determines that the missing region MA can be filled, the data generation unit 414 in step S50 generates shaping data from the first data in such a way that the partial shaped object to fill the missing region MA is generated, whereas when the data generation unit 414 determines that the missing region MA cannot be filled, the data generation unit 414 in step S60 generates shaping data from the first data without filling the missing region MA.

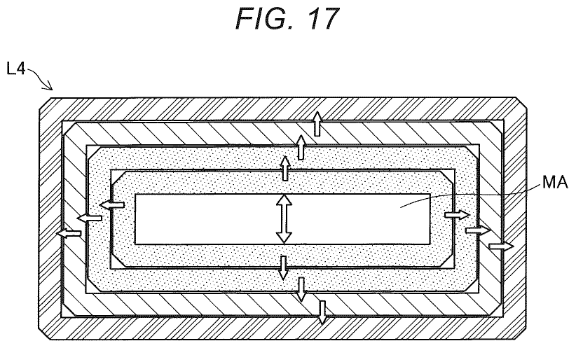

FIG. 17 is a diagram illustrating the state where the missing region MA in a layer L4 is expanded. The data generation unit 414 changes the first data in such a way that a plurality of partial shaped objects surrounding the missing region MA slightly overlaps each other within the range of the allowable amount of overlap, and thus expands the area of the missing region MA. Then, path data and amount-of-ejection data for arranging a new partial shaped object in the expanded missing region MA are generated and added to the first data, thus generating shaping data. The new partial shaped object is, for example, a partial shaped object that makes a full round represented by a circulation path.

According to the fourth embodiment described above, since the partial shaped objects around the missing region MA are slightly superimposed on each other to expand the missing region MA, the inside of the missing region MA is filled more easily.

In the fourth embodiment, in step S30 of the shaping processing, not only the designation of the allowable amount of overlap between the partial shaped objects corresponding to the paths adjacent to each other around the missing region MA is accepted, but also the designation of the allowable amount of overlap of the partial shaped objects corresponding to the paths adjacent to each other in the circulation path may be accepted, as in the first embodiment. In this way, even when the missing region MA is not sufficiently expanded, the partial shaped objects arranged in the missing region MA can be superimposed on each other and therefore the likelihood of being able to fill the missing region MA can be increased.

### E. Fifth Embodiment

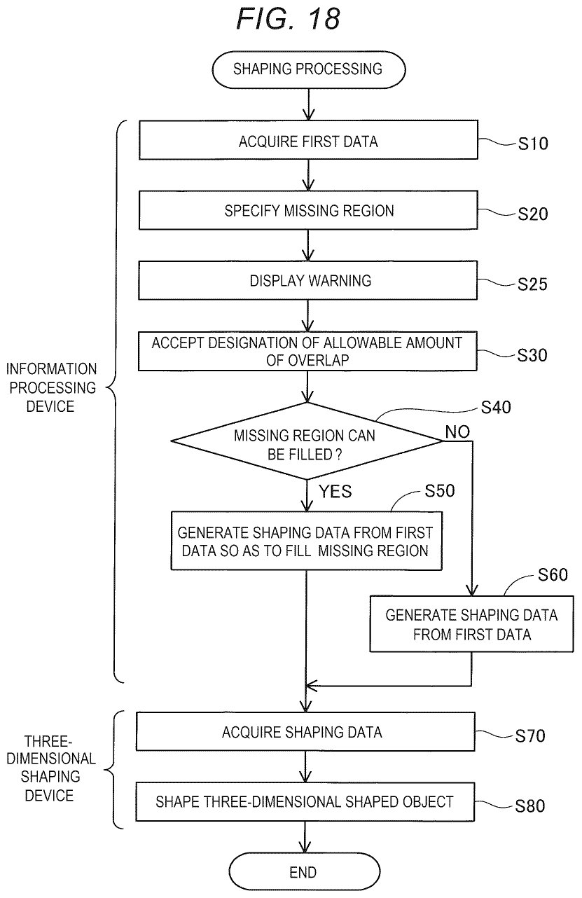

FIG. 18 is a flowchart of shaping processing executed in a fifth embodiment. The configuration of a three-dimensional shaping system 10 according to the fifth embodiment is the same as that of the three-dimensional shaping system 10 according to the first embodiment.

In the fifth embodiment, processing of step S25 is added to the flowchart of the shaping processing shown in FIG. 6. In the fifth embodiment, the processing contents except step S25 are the same as those in the second embodiment. In the fifth embodiment, when the missing region MA is specified in the outline region A1 in step S20, the specifying unit 412 displays a warning on the display unit 480. The display of the warning may be performed, for example, by displaying a pop-up window in which a warning message is described, on the display unit 480, or by displaying a region corresponding to the missing region MA in a blinking manner or in a conspicuous color when the shaping data is visualized on the display unit 480.

According to the fifth embodiment described above, the user can be notified that the missing region MA is generated in the outline region A1, which greatly influences the appearance of the three-dimensional shaped object.

The site where the missing region MA to be the target of warning is generated may be designated by the user as appropriate. For example, the warning may be displayed when the missing region MA is specified in a region designated by the user from among (1) the innermost circumferential region of the circulation path, (2) the outline region A1, and (3) the region between the outline region A1 and the infill region A2. Also, for example, the area of the missing region MA to be the target of warning display may be designated by the user. In this way, if the user can designate the site where the missing region MA to be the target of warning is generated or the area of the missing region MA, the warning about the generation of the missing region MA can be given, based on different criteria from one user to another.

### F. Other Embodiments

(F1) In each of the above-described embodiments, the layer includes the outline region A1 and the infill region A2. Of the outline region A1 and the infill region A2, the outline region A1 may be configured with subdivided regions. Specifically, the outline region A1 may include an outermost perimeter region, which is the outermost region, and an inner perimeter region on the inner side of the outermost perimeter region. In this case, the allowable amount of overlap may be designated separately for the outermost perimeter region and for the inner perimeter region. In this way, even when the missing region MA is generated in each of the outermost perimeter region and the inner perimeter region forming the outline region A1, the likelihood of being able to fill the missing regions MA can be increased in accordance with the separately designated allowable amounts of overlap.

(F2) In the above-described embodiments, the shaping unit 110 plasticizes the material with the flat screw. In contrast, the shaping unit 110 may plasticize the material, for example, by rotating an in-line screw. The shaping unit 110 may also plasticize a filament material with a heater.

### G. Other Aspects

The present disclosure is not limited to the embodiments described above and may be implemented with various configurations without departing from the spirit and scope of the present disclosure. For example, technical features in the embodiments corresponding to technical features in the aspects described below can be replaced or combined as appropriate in order to solve a part or all of the problems described above or in order to achieve a part or all of the effects described above. Such technical features can be deleted as appropriate unless described as essential in the present specification.

(1) According to a first aspect of the present disclosure, a method for manufacturing a three-dimensional shaped object in which a shaping material is ejected from an ejection unit toward a stage to stack a layer, thus manufacturing a three-dimensional shaped object, is provided. This manufacturing method includes: a first process of specifying a missing region in the three-dimensional shaped object, based on first data that includes path data representing a path along which the ejection unit moves relatively to the stage while ejecting the shaping material and that includes amount-of-ejection data representing an amount of ejection of the shaping material in the path; a second process of accepting a designation of an allowable amount of overlap, which is an allowable amount of overlapping of partial shaped objects corresponding to paths adjacent to each other in a same layer; a third process of generating shaping data from the first data in such a way that a partial shaped object to fill the missing region is generated, when it is determined that the missing region can be filled by superimposing the partial shaped objects on each other within a range of the designated allowable amount of overlap; and a fourth process of controlling the relative movement of the ejection unit to the stage, based on the shaping data, and thus shaping the three-dimensional shaped object.

According to this embodiment, a situation where a void part remains in the three-dimensional shaped object, generating a missing part in a part of the three-dimensional shaped object, can be suppressed.

(2) In the above aspect, in the second process, the allowable amount of overlap may be designated for partial shaped objects corresponding to paths adjacent to each other in a circulation path that makes a full round as a continuous path. According to this aspect, the missing region in the circulation path can be filled more easily.

(3) In the above aspect, the layer may include an outline region forming an outline of the three-dimensional shaped object and an infill region located on an inner side of the outline region, and in the second process, the allowable amount of overlap may be designated separately for partial shaped objects corresponding to paths adjacent to each other in the outline region and for partial shaped objects corresponding to paths adjacent to each other in the infill region. According to this aspect, the missing region between the outline region and the infill region can be filled more easily.

(4) In the above aspect, the layer may include an outline region forming an outline of the three-dimensional shaped object and an infill region located on an inner side of the outline region, and in the second process, the allowable amount of overlap may be designated for a partial shaped object corresponding to a path in the outline region and for a partial shaped object corresponding to a path in the infill region which are adjacent to each other. According to this aspect, an appropriate allowable amount of overlap can be designated in accordance with the region where the missing region is generated.

(5) In the above aspect, in the second process, the allowable amount of overlap of partial shaped objects corresponding to paths adjacent to each other around the missing region may be designated, and in the third process, the partial shaped objects corresponding to the paths adjacent to each other around the missing region may be superimposed on each other within the range of the allowable amount of overlap, thus expanding the missing region specified in the first process, and the shaping data may be generated from the first data in such a way that a partial shaped object to fill the expanded missing region is generated. According to this aspect, as the missing region is expanded, the missing region can be filled more easily.

(6) In the above aspect, the layer may include an outline region forming an outline of the three-dimensional shaped object, the outline region may include an outermost perimeter region and an inner perimeter region on an inner side of the outermost perimeter region, and in the second process, the allowable amount of overlap may be designated separately for the outermost perimeter region and for the inner perimeter region.

(7) In the above aspect, the layer may include an outline region forming an outline of the three-dimensional shaped object, and the method may include a process of causing a display unit to display that the missing region is specified in the outline region, when the missing region is specified in the outline region. According to this aspect, the user can be notified that the missing region is generated in the outline region, which greatly influences the appearance of the three-dimensional shaped object.

(8) According to a second aspect of the present disclosure, an information processing device that generates shaping data for ejecting a shaping material from an ejection unit toward a stage to stack a layer and thus forming a three-dimensional shaped object is provided. The information processing device includes: an acquisition unit configured to acquire first data that includes path data representing a path along which the ejection unit moves relatively to the stage while ejecting the shaping material and that includes amount-of-ejection data representing an amount of ejection of the shaping material in the path; a specifying unit configured to specify a missing region in the three-dimensional shaped object, based on the first data; an acceptance unit configured to accept a designation of an allowable amount of overlap, which is an allowable amount of overlapping of partial shaped objects corresponding to paths adjacent to each other in a same layer; and a data generation unit configured to generate shaping data from the first data in such a way that a new partial shaped object filling the missing region is generated, when it is determined that the missing region can be filled by the new partial shaped object including parts superimposed on each other within a range of the designated allowable amount of overlap.

The present disclosure is not limited to the method for manufacturing a three-dimensional shaped object and the information processing device that are described above, and can be implemented in various aspects such as a computer program, or a non-transitory tangible recording medium in which a computer program is recorded in a computer-readable manner.

What is claimed is:

1. A method for manufacturing a three-dimensional shaped object in which a shaping material is ejected from an ejection unit toward a stage to stack a layer, thus manufacturing a three-dimensional shaped object, the method comprising:
a first process of specifying a missing region in the three-dimensional shaped object, based on first data that includes path data representing a path along which the ejection unit moves relatively to the stage while ejecting the shaping material and that includes amount-of-ejection data representing an amount of ejection of the shaping material in the path;
a second process of accepting a designation of an allowable amount of overlap, which is an allowable amount of overlapping of partial shaped objects corresponding to paths adjacent to each other in a same layer;
a third process of generating shaping data from the first data in such a way that a partial shaped object to fill the missing region is generated, when it is determined that the missing region can be filled by superimposing the partial shaped objects on each other within a range of the designated allowable amount of overlap; and
a fourth process of controlling the relative movement of the ejection unit to the stage, based on the shaping data, and thus shaping the three-dimensional shaped object.

2. The method for manufacturing a three-dimensional shaped object according to claim 1, wherein
in the second process, the allowable amount of overlap is designated for partial shaped objects corresponding to paths adjacent to each other in a circulation path that makes a full round as a continuous path.

3. The method for manufacturing a three-dimensional shaped object according to claim 1, wherein
the layer includes an outline region forming an outline of the three-dimensional shaped object and an infill region located on an inner side of the outline region, and
in the second process, the allowable amount of overlap is designated separately for partial shaped objects corresponding to paths adjacent to each other in the outline region and for partial shaped objects corresponding to paths adjacent to each other in the infill region.

4. The method for manufacturing a three-dimensional shaped object according to claim 1, wherein
the layer includes an outline region forming an outline of the three-dimensional shaped object and an infill region located on an inner side of the outline region, and
in the second process, the allowable amount of overlap is designated for a partial shaped object corresponding to a path in the outline region and for a partial shaped object corresponding to a path in the infill region which are adjacent to each other.

5. The method for manufacturing a three-dimensional shaped object according to claim 1, wherein
in the second process, the allowable amount of overlap of partial shaped objects corresponding to paths adjacent to each other around the missing region is designated, and
in the third process, the partial shaped objects corresponding to the paths adjacent to each other around the missing region are superimposed on each other within the range of the allowable amount of overlap, thus expanding the missing region specified in the first process, and the shaping data is generated from the first data in such a way that a partial shaped object to fill the expanded missing region is generated.

6. The method for manufacturing a three-dimensional shaped object according to claim 1, wherein
the layer includes an outline region forming an outline of the three-dimensional shaped object,
the outline region includes an outermost perimeter region and an inner perimeter region on an inner side of the outermost perimeter region, and
in the second process, the allowable amount of overlap is designated separately for the outermost perimeter region and for the inner perimeter region.

7. The method for manufacturing a three-dimensional shaped object according to claim 1, wherein
the layer includes an outline region forming an outline of the three-dimensional shaped object, and
the method further comprises a process of causing a display unit to display that the missing region is specified in the outline region, when the missing region is specified in the outline region.

8. An information processing device that generates shaping data for ejecting a shaping material from an ejection unit toward a stage to stack a layer and thus shaping a three-dimensional shaped object, the information processing device comprising:
an acquisition unit configured to acquire first data that includes path data representing a path along which the ejection unit moves relatively to the stage while ejecting the shaping material and that includes amount-of-ejection data representing an amount of ejection of the shaping material in the path;
a specifying unit configured to specify a missing region in the three-dimensional shaped object, based on the first data;
an acceptance unit configured to accept a designation of an allowable amount of overlap, which is an allowable amount of overlapping of partial shaped objects corresponding to paths adjacent to each other in a same layer; and
a data generation unit configured to generate shaping data from the first data in such a way that a partial shaped object to fill the missing region is generated, when it is determined that the missing region can be filled by superimposing the partial shaped objects on each other within a range of the designated allowable amount of overlap.
